(19) United States
(12) Patent Application Publication
(10) Pub. No.: US 2018/0188685 A1
(43) Pub. Date: Jul. 5, 2018

(54) Monolithic Optical System for Light Propagation in Confined Spaces and Method of Fabrication

(71) Applicant: LUMINIT, LLC, Torrance, CA (US)

(72) Inventors: Fedor Dimov, Redondo Beach, CA (US); Jens Steinigen, Auckland (NZ); Kunal Chaturbhuj Gwalani, Auckland (NZ); Neven Rakuljic, Santa Ana, CA (US); Seth Coe-Sullivan, Redondo Beach, CA (US)

(73) Assignee: LUMINIT, LLC, Torrance, CA (US)

(21) Appl. No.: 15/854,512

(22) Filed: Dec. 26, 2017

Related U.S. Application Data
(60) Provisional application No. 62/440,874, filed on Dec. 30, 2016.

(51) Int. Cl. G03H 1/00; G02B 27/44; G02B 17/00; G02B 19/00

(52) U.S. Cl. CPC G03H 1/0005; G02B 27/44; G03H 2001/0088; G02B 19/0047; G03H 2223/16; G02B 17/002

(57) ABSTRACT

The present application is directed to an optical system made of a microdisplay; a holographic lens; a bent, monolithic, solid light guide; and a transparent holographic grating with a wedge attached to the back. The bent optical waveguide is made from one piece of thermoplastic polymer or is made by 3D printing using thermoplastic polymer.

### BACKGROUND

See-through head-mounted and heads-up displays are a relatively new technology. Most have been used for military applications, though now there is also a huge recreational market. Current displays are expensive to produce, are fragile, and are heavy in weight. These displays also suffer from dimness, lack of contrast, and poor image quality. In addition, these displays have a limited Field of View (FOV) and a smaller eye motion box.

Thus, there is a need for a see-through head-mounted display that is lightweight, sturdy, and inexpensive. Furthermore, it would be advantageous to provide sufficient eye space (eye relief) for prescription glasses and offer a full FOV image.

### SUMMARY

Provided herein is an optical system made of a microdisplay capable of emitting light in the form of an image; a holographic lens capable of accepting light in the form of an image from the microdisplay and capable of transmitting the accepted light in the form of an image; a bent, monolithic, solid light guide capable of accepting the light in the form of an image from the holographic lens and transmitting the light in the form of an image along a length of the light guide without touching the surfaces to avoid guided image deterioration; and a transparent holographic grating capable of accepting the light transmitted from the bent, monolithic, solid light guide and transmitting it to a location outside of the holographic grating as a viewable image. A transparent wedge is attached to the back of the holographic grating to compensate the see-through image shift. The optical system can be made from a thermoplastic polymer, such as acrylic polymer or polycarbonate polymer. The light guide can be machined or lasered from a solid piece of cast thermoplastic polymer, such as acrylic polymer or polycarbonate polymer. The light guide also can be a 3D printed object. The transparent holographic grating is attached to a first surface of the light guide. The holographic lens is attached to a second surface of the light guide.

Also provided herein is a method of manufacturing an optical system including providing a microdisplay capable of emitting light in the form of an image; in the vicinity of the microdisplay, providing a bent, monolithic, solid light guide capable of accepting the light in the form of an image from the holographic lens and transmitting the light in the form of an image along a length of the light guide without touching the surfaces to avoid guided image deterioration; attaching a holographic lens to the light guide, which holographic lens is capable of accepting light in the form of an image from the microdisplay and is capable of transmitting the accepted light in the form of an image; and attaching a transparent holographic grating capable of accepting the light transmitted from the bent, monolithic, solid light guide and transmitting it to a location outside of the holographic grating as a viewable image. A transparent wedge is attached to the back of the holographic grating to compensate the see-through image shift. In this method, the light guide can be a thermoplastic polymer. Alternatively, in this method, the light guide is machined or lasered from a solid piece of cast thermoplastic polymer, such as acrylic or cast polycarbonate. In another method, the light guide can be a 3D printed object made from a thermoplastic polymer, such as acrylic polymer or polycarbonate polymer. In an alternative method, a light guide mould is made using 3D printing that can be filled with thermoplastic polymers to produce additional light guides. In yet another alternative method, a light guide mould is made using aluminum or steel that can be filled with thermoplastic polymer to produce additional light guides.

The optical system described herein has many benefits. One benefit is that a bent light guide has the ability to reorient the light path and reduce distance (length). Another benefit is that such a light guide is inexpensive to produce based on the use of low-cost thermoplastics rather than the high-priced glass of existing systems. Moreover, a cast acrylic light guide offers superior physical, mechanical, and optical properties as compared to those of extruded acrylic. Furthermore, the acrylic-based light guides are lightweight being made from acrylic rather than the glass of existing systems. In addition, it is quick and easy to make, especially in view of the 3D printing technology.

### BRIEF DESCRIPTION OF THE DRAWINGS

FIG. 1 is a rendition of a 3D model of one embodiment of the application.

FIG. 2 is a Wire frame model of one embodiment, top view.

FIG. 3 is a Wire frame model of one embodiment, left side view.

FIG. 4 is a Wire frame model of one embodiment, right side view.

FIG. 5 is a Wire frame model of one embodiment, bottom view.

FIG. 6 is an Isometric wireframe model of one embodiment, South East view of 3D model.

FIG. 7 is an Isometric wireframe model of one embodiment, South West view of 3D model.

FIG. 8 is one embodiment of the optical system described herein.

FIG. 9 is 3 image projections of the wedge.

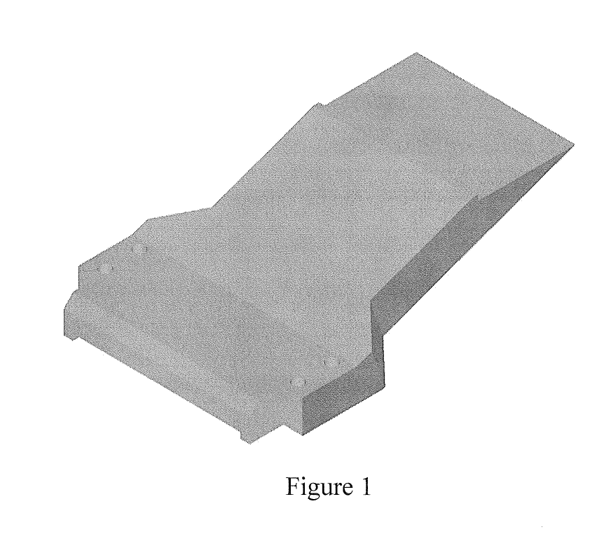

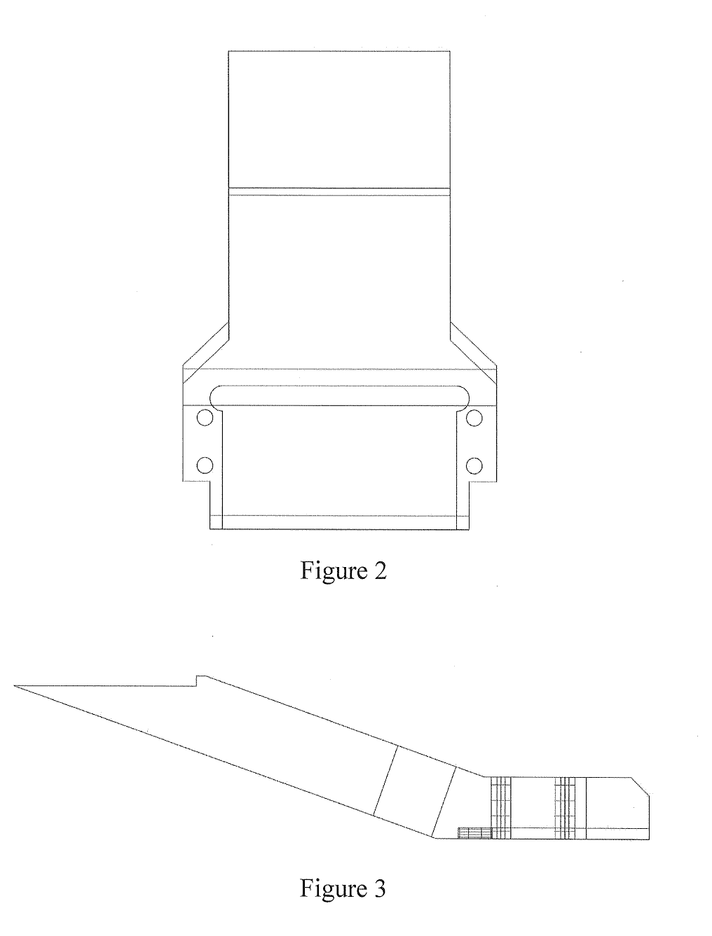

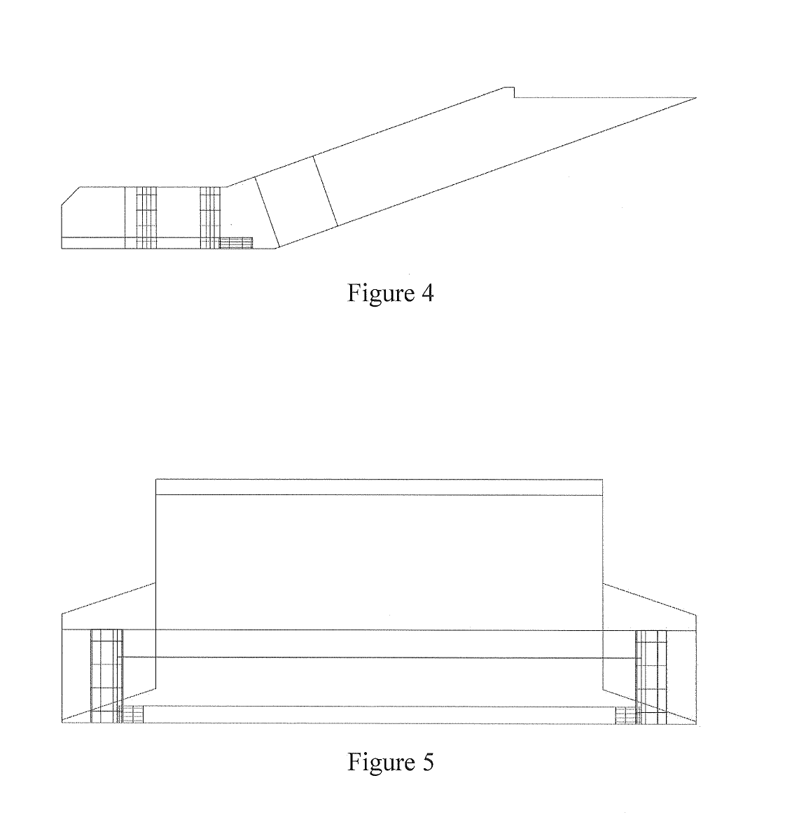

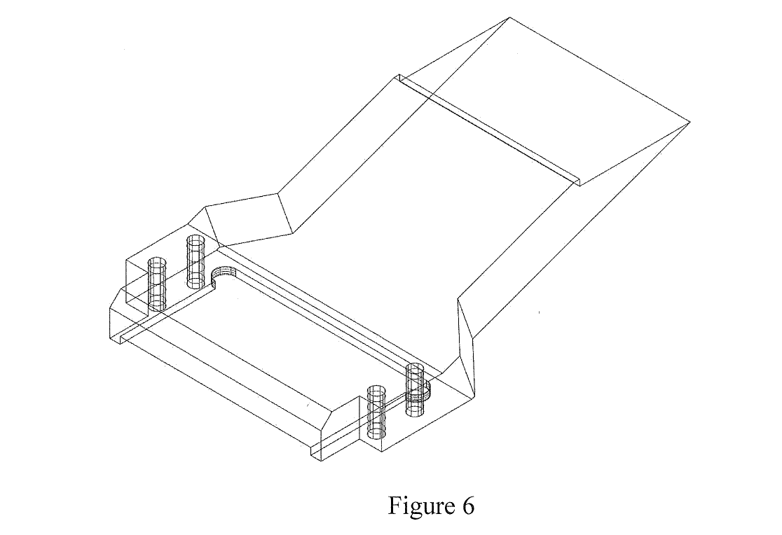

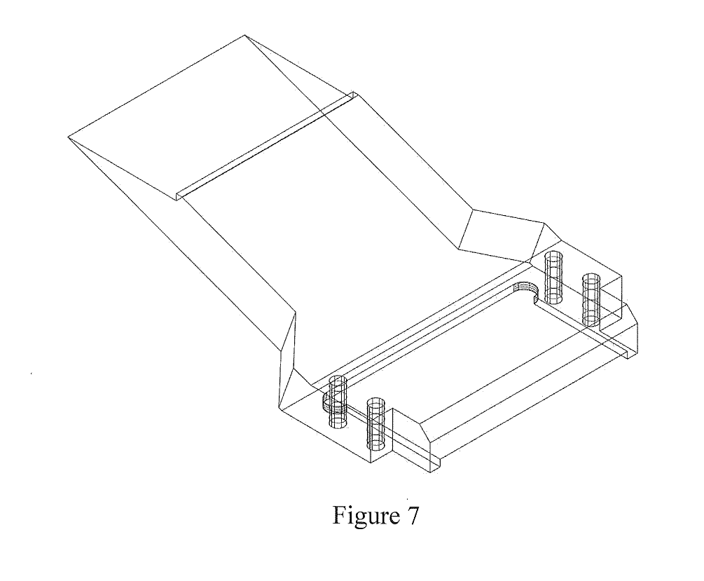

### DETAILED DESCRIPTION

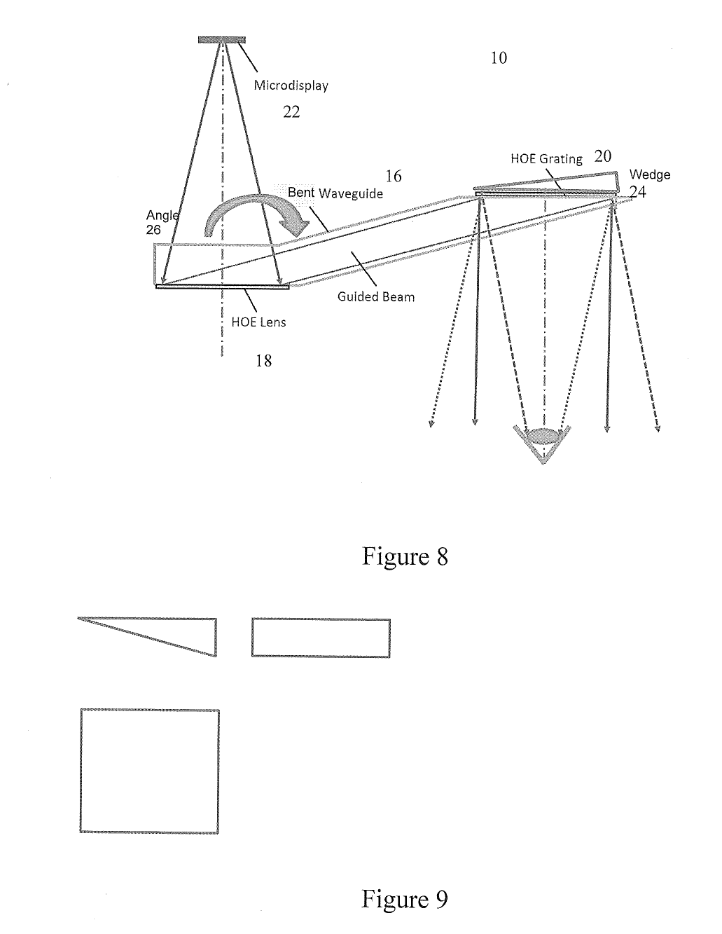

The present application is directed to an optical system (10), as shown in FIG. 8, made of a microdisplay (22) capable of emitting light in the form of an image; a holographic lens (18) capable of accepting light in the form of an image from the microdisplay (22) and capable of transmitting the accepted light in the form of an image; a bent, monolithic, solid, light guide (16) capable of accepting the light in the form of an image from the holographic lens (18) and transmitting the light in the form of an image along a length of the light guide (16) without touching the surfaces to avoid guided image deterioration; and a transparent holographic grating (20) capable of accepting the light transmitted from the bent, monolithic, solid light guide (16) and transmitting it to a location outside of the holographic grating (20) as a viewable image. The transparent holographic grating (20) is attached to a first surface of the light guide (16). The holographic lens (18) is attached to a second surface of the light guide (16). To compensate the see-through image shift, a transparent wedge (24) is added to the back of the holographic grating. The optical system (10) can be made from thermoplastic polymer, which can be machined or lasered from a solid piece of cast thermopolymer. Examples of useful thermopolymers include acrylic or polycarbonate. The light guide (16) alternatively can be a 3D printed object made using a 3D printer and a thermoplastic polymer, such as acrylic polymer or polycarbonate polymer. The thickness of the light guide ranges from 0.3-6 mm. The bend of the light guide structure can be from 1-179 degrees, shown as the angle (26), arrow. The angle, thickness, and length of waveguide could vary depending on the application as these parameters are defined by eyebox size and distance from the eye.

Also provided herein is a method of manufacturing an optical system (10) including providing a microdisplay (22) capable of emitting light in the form of an image; in the vicinity of the microdisplay (22), providing a bent, monolithic, solid, light guide (16) capable of accepting the light in the form of an image without touching the surfaces to avoid guided image deterioration; attaching a holographic lens (18) to the light guide (16), which holographic lens (18) is capable of accepting light in the form of an image from the microdisplay (22) and is capable of transmitting the accepted light in the form of an image; and attaching a transparent holographic grating (20) capable of accepting the light transmitted from the bent, monolithic, solid light guide (16) and transmitting it to a location outside of the holographic grating (20) as a viewable image. In this method, the light guide (16) can be thermoplastic polymer. Also, in this method, the light guide (16) is machined or lasered from a solid piece of cast thermopolymer, such acrylic or polycarbonate. In this method, alternatively the light guide (16) can be a 3D printed object made from a thermoplastic polymer, such acrylic polymer or polycarbonate polymer. In an alternative embodiment of the method, a light guide mould is made using 3D printing that can be filled with thermoplastic polymers to produce additional light guides (16). In yet another alternative method, a light guide mould is made using aluminum or steel that can be filled with thermoplastic polymer to produce additional light guides (16). The thickness of the light guide (16) ranges from 0.3-6 mm. The bend of the light guide (16) can be from 1-179 degrees.

### EXAMPLES

### Fabrication & Manufacturing Processes

CNC Machining of Light Guide from Solid Piece of Cast Acrylic.

The main advantage of this process is that there is no need for moulds; therefore, the lead time is significantly reduced, and the cost is less. For this process, cast acrylic is selected as it offers superior physical, mechanical and optical properties compared to extruded acrylic. The process includes laser cutting and CNC machining the light guide and wedge, utilizing a suitable jig fixture to stabilize and hold the light guide during machining and drilling holes, followed by polishing the machined surfaces for optical clarity.

### 3D Printing Acrylic Light Guide.

3D or additive printing of optical components from thermoplastic polymers such as acrylic is now technically feasible. This process offers the advantage that no moulds are required as the light guides are directly printed from digital 3D CAD file and available on demand. As the technology doesn't allow light guides to be printed with an overhang (i.e. hollow beneath) and although this lightguide has a ‘bend’, which creates an overhang, the light guide can be oriented on its side for the purposes of 3D printing.

Vacuum Casting of Acrylic Light Guide with Liquid Silicone Rubber Moulding.

The main advantage of this process is that tools can be made quickly and in small batches at low cost. The process includes making an accurate pattern or finished form of the light guide by 3D printing using the SLA process or CNC machining. This form is then encapsulated in liquid silicone rubber, vacuum applied and then cured in an oven to form the mould which is then split to reveal the cavity when the form of the light guide is removed. The light guide would be moulded with acrylic resin or other suitable thermoplastic resin with the required optical properties using this process.

Injection Moulding of Acrylic Light Guide with Aluminum or Steel Moulds.

Aluminum as a mould material is easy to work with and dissipates heat well. An aluminum mould with single or multi-cavity is well suited for producing around 10,000 components. Although the cycle times are slightly higher for aluminum moulds compared to steel moulds, aluminum moulds are well suited for lower quantity production. For higher volume production, steel moulds with multi-cavities are specified. Aluminum and steel moulds of the light guide are made using various methods like CNC machining, EDM wire cutting, spark erosion and hand finishing. The light guide and wedge would be moulded with acrylic resin or other suitable thermoplastic resin with the required optical properties using this process.

We claim:

1. An optical system comprising:
(a) a microdisplay capable of emitting light in the form of an image;
(b) a holographic lens capable of accepting light in the form of an image from the microdisplay and capable of transmitting the accepted light in the form of an image;
(c) a bent, monolithic, solid light guide capable of accepting the light in the form of an image from the holographic lens and transmitting the light in the form of an image along a length of the light guide without touching the surfaces to avoid guided image deterioration;
(d) a transparent holographic grating capable of accepting the light transmitted from the bent, monolithic, solid, light guide and transmitting it to a location outside of the holographic grating as a viewable image; and
(e) a transparent wedge attached to the back of the holographic grating to compensate a see-through image shift.

2. The optical system of claim 1 wherein the light guide comprises a thermoplastic polymer.

3. The optical system of claim 1 wherein the light guide is machined or lasered from a solid piece of cast thermoplastic polymer.

4. The optical system of claim 1 wherein the light guide comprises a 3D printed object.

5. The optical system of claim 1 wherein the transparent holographic grating is attached to a first surface of the light guide, and wedge is attached to the back of holographic grating

6. The optical system of claim 1 wherein the holographic lens is attached to a second surface of the light guide.

7. A method of manufacturing an optical system comprising:
(a) providing a microdisplay capable of emitting light in the form of an image;
(b) in the vicinity of the microdisplay, providing a bent, monolithic, solid light guide capable of accepting the light in the form of an image without touching the surfaces to avoid guided image deterioration;
(c) attaching a holographic lens to the light guide, which holographic lens is capable of accepting light in the form of an image from the microdisplay and is capable of transmitting the accepted light in the form of an image; and
(d) attaching a transparent holographic grating capable of accepting the light transmitted from the bent, monolithic, solid, light guide and transmitting it to a location outside of the holographic grating as a viewable image wherein a wedge is attached to the back of the holographic lens to compensate a see-through image shift.

8. The method of claim 7 wherein the light guide comprises a thermoplastic polymer.

9. The method of claim 7 wherein the light guide is machined or lasered from a solid piece of cast thermoplastic polymer.

10. The method of claim 7 wherein the light guide comprises a 3D printed object.

11. The method of claim 7 wherein a light guide mould is made using 3D printing, that can be filled with thermoplastic polymers to produce additional light guides.

12. The method of claim 7 wherein a light guide mould is made using aluminum or steel that can be filled with thermoplastic polymer to produce additional light guides.
